(19) United States
(12) Patent Application Publication
(10) Pub. No.: US 2018/0094690 A1
(43) Pub. Date: Apr. 5, 2018

(54) CYLINDER DEVICE

(71) Applicant: Hitachi Automotive Systems, Ltd., Ibaraki (JP)

(72) Inventors: Umi TANABE, Ibaraki (JP); Yusei KIMURA, Ibaraki (JP)

(21) Appl. No.: 15/562,474

(22) PCT Filed: Aug. 24, 2016
(86) PCT No.: PCT/JP2016/074651

§ 371 Date: Sep. 28, 2017

(30) Foreign Application Priority Data
Aug. 31, 2015 (JP) 2015-171298

(51) Int. Cl. F16F 9/32; F16F 9/53

(52) U.S. Cl. CPC F16F 9/3235; F16F 9/34; F16F 9/53

(57) ABSTRACT

Provided is a cylinder device including: an inner cylinder in which a functional fluid, a fluid property of which is changed due to an electric field or a magnetic field, is encapsulated; an outer cylinder provided outside the inner cylinder; and a flow path forming unit provided between the inner cylinder and the outer cylinder so as to define a flow path through which the functional fluid flows by advancing and retracting movements of the rod from a first end side to a second end side in an axial direction, and configured to he relatively non-rotatable relative to the inner cylinder or the outer cylinder. The flow path obliquely extends around the inner cylinder or the flow path forming unit, and the flow path has a first portion extending m a first oblique direction and a second portion extending in a second oblique direction opposite to the first oblique direction.

### CROSS REFERENCE TO RELATED APPLICATIONS

This application is a national phase of PCT application No. PCT/JP2016/074651, filed on 24 Aug. 2016, which claims priority from Japanese patent application No. 2015-171298, filed on 31 Aug. 2015, all of which are incorporated herein by reference.

### TECHNICAL FIELD

The present disclosure relates to a cylinder device suitably used to absorb vibration of a vehicle such as, for example, an automobile or a railway vehicle.

### BACKGROUND

In general, in a vehicle such as an automobile, a cylinder device represented by a hydraulic shock absorber is provided between a vehicle body (sprang) side and each vehicle wheel (unsprung) side. Here, Patent Document 1 discloses a damper (shock absorber) using an electrorheological fluid and having a configuration in which a spiral members are provided between an inner cylinder and an outer cylinder so as to a flow path between the spiral members.

### PRIOR ART DOCUMENT

### Patent Document

Patent Document 1: International Publication No. WO 2014/135183

### DISCLOSURE OF THE INVENTION

### Problems to be Solved

In the configuration of Patent Document 1, for example, a rotational force (torque) is applied to the outer cylinder based on the shear resistance of the fluid (electrorheological fluid) flowing between the spiral members. When the rotational force is large, the configuration is likely to be disadvantageous in terms of durability, for example.

An object of the present invention is to provide a cylinder device capable of reducing a rotational force applied from a fluid.

### Means to Solve the Problems

A cylinder device according to an exemplary embodiment of the present invention includes: an inner cylinder in which a functional fluid having fluid characteristics that are changed by an electric field or a magnetic field is encapsulated and into which a rod is inserted; an outer cylinder which is provided outside the inner cylinder; and a flow path forming unit which is provided between the inner cylinder and the outer cylinder, defines a flow path through which the functional fluid flows by advancing and retracting movements of the rod from a first end side to a second end side in an axial direction, and is prevented from being rotated relative to the inner cylinder or the outer cylinder, in which the flow path obliquely extends around the inner cylinder or the flow path forming unit, and the flow path has a first portion extending in a first oblique direction and a second portion extending in a second oblique direction opposite to the first oblique direction.

According to the cylinder de vice according to the exemplary embodiment of the present invention, it is possible to reduce a rotational force applied from a fluid.

### BRIEF DESCRIPTION OF THE DRAWINGS

FIG. 1 is a longitudinal sectional view illustrating a shock absorber as a cylinder device according to an exemplary embodiment.

FIG. 2 is a perspective view illustrating an inner cylinder.

FIG. 3 is a side view illustrating the inner cylinder.

FIG. 4 is a development view illustrating the inner cylinder.

FIG. 5 is a characteristic diagram illustrating an example of a relationship between an axial position of the inner cylinder and viscosity of a fluid.

FIG. 6 is a characteristic diagram illustrating another example of the relationship between the axial position of the inner cylinder and the viscosity of the fluid.

### DETAILED DESCRIPTION TO EXECUTE THE INVENTION

Hereinafter, a cylinder device according to an exemplary embodiment, which is applied, for example, to a shock absorber provided in a vehicle such as, for example, a four-wheeled automobile, will be described with reference to the accompanying drawings.

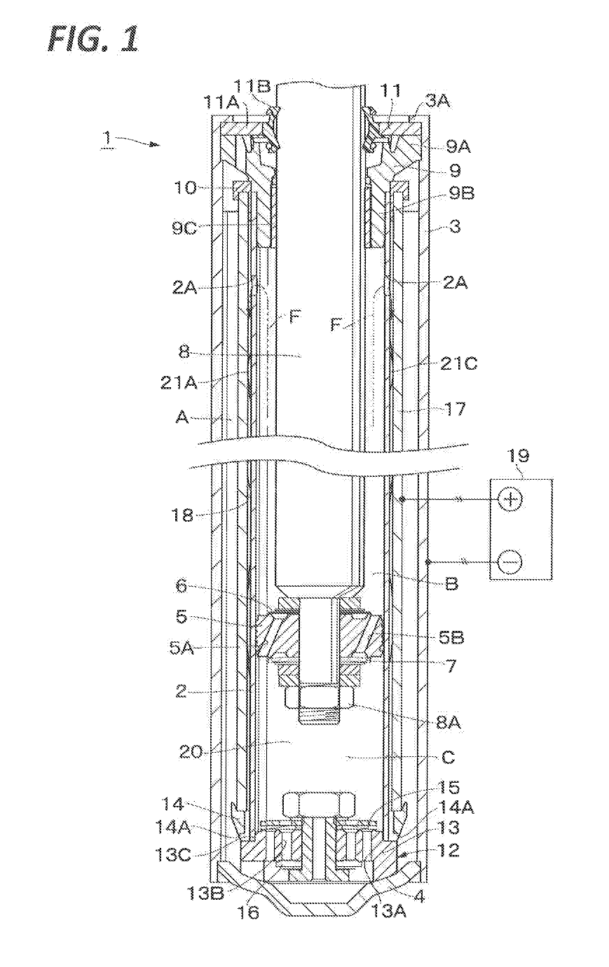

In FIG. 1, a shock absorber 1, as a cylinder device, is configured as a damping force regulation type hydraulic shock absorber (semi-active damper) using a functional fluid (i.e., electrorheological fluid) as a working fluid 20 such as, for example, a hydraulic oil encapsulated in the shock absorber 1. For example, the shock absorber 1 constitutes a suspension apparatus for a vehicle together with a suspension spring (not illustrated) formed as a coil spring. Further, in the following description, the first end side in an axial direction of the shock absorber 1 will be referred to as an “upper end side”, and the second end side in the axial direction will be referred to as a “lower end side”.

The shock absorber 1 includes an inner cylinder 2, an outer cylinder 3, a piston 5, a piston rod 8, and an intermediate cylinder 17. The inner cylinder 2 is formed as a cylinder body extending in an axial direction, and the working fluid 20 (i.e., functional fluid) to be described below is encapsulated in the inner cylinder 2. The piston rod 8 to be described below is inserted into the inner cylinder 2, and the outer cylinder 3 is coaxially provided outside the inner cylinder 2.

The outer cylinder 3 defines an outer shell of the shock absorber 1, and the outer cylinder 3 is formed as a cylinder body. A lower end side of the outer cylinder 3 is formed as a blocked end which is blocked by a bottom cap 4 by means of a welding process or the like. The bottom cap 4 constitutes a base member together with a valve body 13 of a bottom valve 12 to be described below. An upper end side of the outer cylinder 3 is an opening end, and a caulking portion 3A is formed to be bent radially inward at the opening end side. The caulking portion 3A holds an outer circumferential side of an annular plate body 11A of a seal member 11 in a slip-out prevention state.

Meanwhile, the inner cylinder 2 is provided inside the outer cylinder 3 to be coaxial with the outer cylinder 3. The lower end side of the inner cylinder 2 is fitted and mounted to the valve body 13 of the bottom valve 12, and the upper end side of the inner cylinder 2 is fitted and mounted to a rod guide 9. As lateral holes in a radial direction, a plurality of (e.g., four) oil holes 2A, which always communicates with a flow path 18 to be described below, is formed in the inner cylinder 2 to be spaced apart from one another in a circumferential direction. A rod side oil chamber B in the inner cylinder 2 communicates with the flow path 18 through the oil holes 2A.

The inner cylinder 2 constitutes a cylinder together with the outer cylinder 3, and the working fluid 20 is encapsulated in the cylinder. Here, in the exemplary embodiment, an electrorheological fluid (ERF) is used as the fluid accommodated (encapsulated) in the cylinder, that is, the working fluid 20 which is hydraulic oil. Further, FIG. 1 illustrates that the encapsulated working fluid 20 is colorless and transparent.

The electrorheological fluid is a kind of a functional fluid having fluid characteristics that are changed by an electric field, and an electrorheological fluid is a fluid having characteristics that are changed by an electric field (voltage). That is, the flow resistance (damping force) of the electrorheological fluid is changed in response to a voltage applied thereto. For example, the electrorheological fluid includes a base oil which is silicon oil or the like, and particles (fine particles) which are mixed with (dispersed in) the base oil such that the viscosity of the electrorheological fluid may be changed in response to a change in the electric field. The shock absorber 1 is configured to control (regulate) generated damping force by generating a potential difference in the flow path 18 to be described below, and controlling the viscosity of the electrorheological fluid passing through the flow path 18. Further, in the present exemplary embodiment, the functional fluid such as the electrorheological fluid is described as an example, but a hydraulic fluid such as oil or water may be used.

An annular reservoir chamber A is formed between the inner cylinder 2 and the outer cylinder 3. A gas is encapsulated in the reservoir chamber A, together with the working fluid 20. As the gas, air at atmospheric pressure may be used, or gas such as compressed nitrogen gas may be used. The gas in the reservoir chamber A is compressed to compensate for an inserted volume of the piston rod 8 when the piston rod 8 is retracted (retraction stroke).

The piston 5 is slidably fitted (inserted) into the inner cylinder 2. The piston 5 divides an interior of the inner cylinder 2 into a rod side oil chamber B and a bottom side oil chamber C. A plurality of oil passages 5A and 5B, which allows the rod side oil chamber B and the bottom side oil chamber C to communicate with each other, is formed in the piston 5 to be spaced apart from each other in the circumferential direction. Here, the shock absorber 1 according to the exemplary embodiment has a uniflow structure. For this reason, the working fluid 20 in the inner cylinder 2 always flows in one direction (i.e., the direction indicated by the arrow F with alternate two-dot chain lines in FIG. 1) from the rod side oil chamber B (i.e., the oil hole 2A of the inner cylinder 2) to the flow path 18 during both of the retraction stroke and the extension stroke of the piston rod 8.

In order to implement this uniflow structure, for example, a retraction side check valve 6, which is opened while the piston 5 slides downward in the inner cylinder 2 in the retraction stroke of the piston rod 8, and closed in a period other than the retraction stroke, is provided at an upper end surface of the piston 5. The retraction side check valve 6 permits the oil (working fluid 20) in the bottom side oil chamber C to flow in the oil passage 5A toward the rod side oil chamber B, and prevents the oil from flowing in the reverse direction.

For example, an extension side disk valve 7 is provided at a lower end surface of the piston 5. The extension side disk valve 7 is opened when a pressure in the rod side oil chamber B exceeds a relief setting pressure when the piston 5 slides upward in the inner cylinder 2 during the extension stroke of the piston rod 8, and the extension side disk valve 7 relieves the pressure toward the bottom side oil chamber C through the oil passage 5B.

The piston rod 8, as a rod, extends in the inner cylinder 2 in the axial direction (direction equal to a central axis of the inner cylinder 2 and the outer cylinder 3, that is, the shock absorber 1, an up and down direction in FIG. 1). That is, a lower end side of the piston rod 8 is connected (fixed) to the piston 5 in the inner cylinder 2, and an upper end side of the piston rod 8 extends to the outside of the inner cylinder 2 and the outer cylinder 3 that constitute the cylinder. In this case, the piston 5 is fixed (bonded) to the lower end side of the piston rod 8 using a nut 8A. Meanwhile, the upper end side of the piston rod 8 protrudes to the outside through the rod guide 9. Further, a lower end of the piston rod 8 may further extend and protrude outward from a bottom portion (e.g., the bottom cap 4) such that the piston rod 8 may be a so-called double rod.

The rod guide 9 having a stepped cylindrical shape is fitted and mounted to the upper end sides of the inner cylinder 2 and the outer cylinder 3 so as to block the upper end sides of the inner cylinder 2 and the outer cylinder 3. The rod guide 9 supports the piston rod 8, and, for example, the rod guide 9 is formed as a cylinder body having a predetermined shape by performing molding, cutting, or the like on a metallic material, a hard resin material, or the like. The rod guide 9 positions the upper portion of the inner cylinder 2 and the upper portion of the intermediate cylinder 17 to be described below at a center of the outer cylinder 3. In addition, the rod guide 9 guides the piston rod 8 such that the piston rod 8 may slide in the axial direction at an inner circumferential side.

Here, the rod guide 9 is formed in a stepped cylindrical shape by an annular large diameter portion 9A which is positioned at an upper side and fitted and mounted to the inner circumferential side of the outer cylinder 3, and a short cylindrical small diameter portion 9B which is positioned at a lower side of the large diameter portion 9A and fitted and mounted to an inner circumferential side of the inner cylinder 2. A guide portion 9C, which guides the piston rod 8 such that the piston rod 8 may slide in the axial direction, is provided at an inner circumferential side of the small diameter portion 9B of the rod guide 9. For example, the guide portion 9C is formed by coating the inner circumferential surface of a metallic cylinder with tetrafluoroethylene.

Meanwhile, an annular holding member 10 is fitted and mounted between the large diameter portion 9A and the small diameter portion 9B at an outer circumferential side of the rod guide 9. The holding member 10 holds the upper end side of the intermediate cylinder 17 to be described below in a state in which the upper end side of the intermediate cylinder 17 is positioned in the axial direction. For example, the holding member 10 is made of an electrically insulating material (isolator), and holds the inner cylinder 2, the rod guide 9, and the intermediate cylinder 17 in the electrically insulated state.

The annular seal member 11 is provided between the large diameter portion 9A of the rod guide 9 and the caulking portion 3A of the outer cylinder 3. The seal member 11 includes a metallic annular plate body 11A which has a hole, at a center thereof, into which the piston rod 8 is inserted, and an elastic body 11B made of an elastic material such as rubber is bonded to the annular plate body 11A by baking or the like. The seal member 11 seals a portion between the seal member 11 and the piston rod 8 in a liquid-tight and gas-tight manner as an inner circumference of the elastic body 11B comes into slide contact with an outer circumferential side of the piston rod 8.

The bottom valve 12 is provided at the lower end side (first end side) of the inner cylinder 2 to be positioned between the inner cylinder 2 and the bottom cap 4. The bottom valve 12 includes the valve body 13, an extension side check valve 15, and a disk valve 16. The valve body 13 partitions the reservoir chamber A and the bottom side oil chamber C between the bottom cap 4 and the inner cylinder 2. Oil passages 13A and 13B, which enable the reservoir chamber A and the bottom side oil chamber C to communicate with each other, are formed in the valve body 13 to be spaced apart from each other at an interval in the circumferential direction.

A stepped portion 13C is formed at an outer circumferential side of the valve body 13, and an inner circumferential side at a lower end of the inner cylinder 2 is fitted and fixed to the stepped portion 13C. In addition, at the stepped portion 13C, an annular holding member 14 is fitted and mounted to an outer circumferential side of the inner cylinder 2. The holding member 14 holds the lower end side of the intermediate cylinder 17 to be described below in a state in which the lower end side of the intermediate cylinder 17 is positioned in the axial direction. For example, the holding member 14 is made of an electrically insulating material (isolator), and maintains the inner cylinder 2, the valve body 13, and the intermediate cylinder 17 in the electrically insulated state. In addition, a plurality of oil passages 14A, which allows the flow path 18 to be described below to communicate with the reservoir chamber A, is formed in the holding member 14.

For example, the extension side check valve 15 is provided at an upper surface side of the valve body 13. The extension side check valve 15 is opened while the piston 5 slides upward during the extension stroke of the piston rod 8, and closed in a period other than the extension stroke. The extension side check-valve 15 permits the oil (working fluid 20) in the reservoir chamber A to flow in the oil passage 13A toward the bottom side oil chamber C, and prevents the oil from flowing in the reverse direction.

For example, the retraction side disk valve 16 is provided at the lower surface side of the valve body 13. The retraction side disk valve 16 is opened when a pressure in the bottom side oil chamber C exceeds a relief setting pressure when the piston 5 slides downward during the retraction stroke of the piston rod 8, and the retraction side disk valve 16 relives the pressure toward the reservoir chamber A through the oil passage 13B.

The intermediate cylinder 17, which is a flow path forming unit formed of a pressure pipe extending in the axial direction, is provided between the outer cylinder 3 and the inner cylinder 2. The intermediate cylinder 17 is made of an electrically conductive material, and constitutes a cylindrical electrode. Between the intermediate cylinder 17 and the inner cylinder 2, the intermediate cylinder 17 defines the flow paths (passages) 18 (18A, 18B, 18C, and 18D) through which the working fluid 20 flows as the piston rod 8 reciprocates from the upper end side to the lower end side in the axial direction.

That is, the intermediate cylinder 17 is mounted through the holding members 10 and 14 which are provided to be spaced apart from each other in the axial direction (up and down direction) at the outer circumferential side of the inner cylinder 2. In this case, the upper end side of the intermediate cylinder 17 is prevented from being rotated relative to the outer cylinder 3 by the holding member 10 and the rod guide 9, and the lower end side of the intermediate cylinder 17 is prevented from being rotated relative to the outer cylinder 3 by the holding member 14, the valve body 13, and the bottom cap 4. Further, the intermediate cylinder 17 has therein an annular passage extending to surround the entire outer circumferential side of the inner cylinder 2, that is, the flow path 18 through which the working fluid 20 flows.

The flow path 18 always communicates with the rod side oil chamber B by the hole 2A which is formed as a lateral hole in the inner cylinder 2 in the radial direction. That is, the flow direction of the working fluid 20 is indicated by the arrow F in FIG. 1, and in the shock absorber 1, the working fluid 20 flows into the flow path 18 through the oil hole 2A from the rod side oil chamber B during both of the compression stroke and the extension stroke of the piston 5. While the piston rod 8 advances and retracts in the inner cylinder 2 (i.e., while the retraction stroke and the extension stroke are repeated), the working fluid 20 flowing into the flow path 18 flows from the upper end side to the lower end side in the axial direction of the flow path 18 by the advancing and retracting movements.

The working fluid 20 flowing into the flow path 18 is discharged to the reservoir chamber A through an oil passage 14A of the holding member 14 from the lower end side of the intermediate cylinder 17. In this case, the pressure of the working fluid 20 is the highest at an upstream side of the flow path 18 (i.e., at the side of the oil hole 2A), and gradually decreases because flow path (passage) resistance is applied while the working fluid 20 flows in the flow path 18. For this reason, the working fluid 20 in the flow path 18 has the lowest pressure when the working fluid 20 flows through the downstream side of the flow path 18 (i.e., the oil passage 14A of the holding member 14).

The flow path 18 applies resistance to the fluid which flows when the piston 5 slides in the outer cylinder 3 and the inner cylinder 2, that is, the electrorheological fluid which is the working fluid 20. For this reason, the intermediate cylinder 17 is connected to a positive pole of a battery 19 which is a power source, for example, through a high voltage driver (not illustrated) that generates high voltage. The intermediate cylinder 17 is an electrode which applies an electric field to the working fluid 20 which is the fluid in the flow path 18, that is, the electrorheological fluid as the functional fluid. In this case, both end sides of the intermediate cylinder 17 are electrically insulated by the electrically insulating holding members 10 and 14. Meanwhile, the inner cylinder 2 is connected to a negative pole (ground) through the rod guide 9, the bottom valve 12, the bottom cap 4, the outer cylinder 3, the high voltage driver, and the like.

The high voltage driver raises a direct current (DC) voltage output from the battery 19 and supplies (outputs) the raised direct current voltage to the intermediate cylinder 17 based on a command (high voltage command) output from a controller (not illustrated) for variably regulating the damping force of the shock absorber 1. Therefore, a potential difference occurs, in response to the voltage applied to the intermediate cylinder 17, between the intermediate cylinder 17 and the inner cylinder 2, that is, in the flow path 18, and the viscosity of the electrorheological fluid varies. In this case, the shock absorber 1 may continuously regulate the generated damping force property from a hard property to a soft property in response to the voltage applied to the intermediate cylinder 17. Further, the shock absorber 1 may regulate the damping force property through two or more steps instead of continuously adjusting the damping force property.

By the way, Patent Document 1 discloses a configuration in which spiral members (partition walls that continuously goes around in one direction) are provided between an inner cylinder and an outer cylinder of a damper (shock absorber) using an electrorheological fluid, and a flow path is formed between the spiral members. In the case of this configuration, the length of the flow path may be secured by forming the flow path in a spiral shape. However, because the fluid (electrorheological fluid) flowing between the spiral members is continuously provided (flows) in one direction the outer cylinder may he rotated when a relational force (torque) is applied to the outer cylinder based on shear resistance of the fluid. For this reason, a rotation stopper (e.g., a claw portion and an engaged portion with which the claw portion is engaged) for receiving the rotational force needs to be provided on the outer cylinder, which may cause the structure to be complicated, and productivity to deteriorate. Furthermore, a repeated load (torque) is applied to the portion (e.g., the claw portion and the engaged portion with which the claw portion is engaged) on which the rotation stopper is provided, which be disadvantageous in terms of durability since abrasion may easily occur.

In contrast, in the exemplary embodiment, the flow path 18 includes four flow paths 18A, 18B, 18C, and 18D that obliquely extend around the inner circumferential side of the intermediate cylinder 17. In this case, a first portion of each of the flow paths 18A, 18B, 18C, and 18D extends in a first oblique direction (e.g., a clockwise direction when viewed from the caulking portion 3A of the outer cylinder 3), and a second portion of each of the flow paths 18A, 18B, 18C, and 18D extends in a second oblique direction (e.g., a counterclockwise direction when viewed from the caulking portion 3A of the outer cylinder 3) opposite to the first oblique direction. Therefore, a force of the fluid flowing through the flow path in the second oblique direction acts to cancel a force of the fluid flowing through the flow path in the first oblique direction, and as a result, it is possible to reduce the (total) rotational force (torque, moment) applied to the inner cylinder 2 from the working fluid 20. Further, in the present exemplary embodiment, the four flow paths are provided, but a single flow path may be provided.

In this end, four partition walls 21A, 21B, 21C, and 21D, which obliquely extend around the intermediate cylinder 17 and the inner cylinder 2, are provided at the outer circumferential side of the inner cylinder 2. The partition walls 21A, 21B, 21C, and 21D partition the flow paths 18A, 18B, 18C, and 18D, and the partition walls 21A, 21B, 21C, and 21D are fixed to the inner cylinder 2 (provided integrally with the inner cylinder 2). For example, the height dimension (thickness in the radial direction) of each of the partition walls 21A, 21B, 21C, and 21D, is set to be equal to or less than a spacing dimension between a portion of the inner circumferential surface of the inner cylinder 2, which comes out of each of the partition walls 21A, 21B, 21C, and 21D, and the inner circumferential surface of the intermediate cylinder 17. Particularly, the height dimension and the spacing dimension are equal to each other in order to prevent the working fluid 20 flowing through the four flow paths 18A, 18B, 18C, and 18D from being discharged while flowing over the respective partition walls 21A, 21B, 21C, and 21D to the flow paths 18A, 18B, 18C, and 18D adjacent to one another in the circumferential direction.

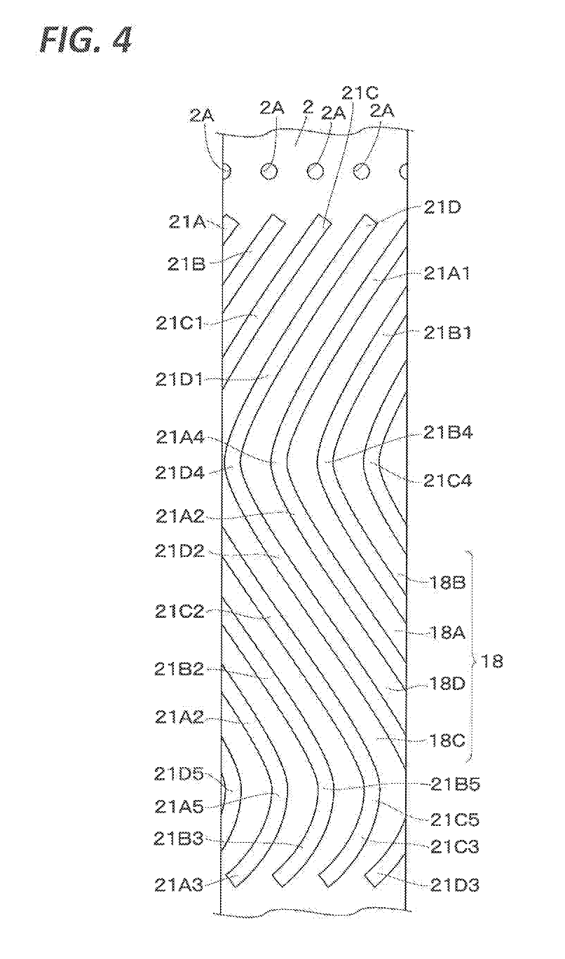

As illustrated in a development view in FIG. 4, a first portion of each of the partition walls 21A, 21B, 21C, and 21D extends in the first oblique direction (e.g., the clockwise direction or the counterclockwise direction) and a second portion of each of the partition walls 21A, 21B, 21C, and 21D extends in the second oblique direction (e.g., the counterclockwise direction or the clockwise direction) opposite to the first oblique direction, like a wavy line such as a sine curve and a cosine curve (e.g., a curve or a straight line which is turned back in the counterclockwise direction, which is opposite to the clockwise direction, before turning around the circumference of the intermediate cylinder 17 once in the clockwise direction, and on the contrary, a curve or a straight line which is turned back in the clockwise direction, which is opposite to the counterclockwise direction, before turning around the circumference of the intermediate cylinder 17 once in the counterclockwise direction).

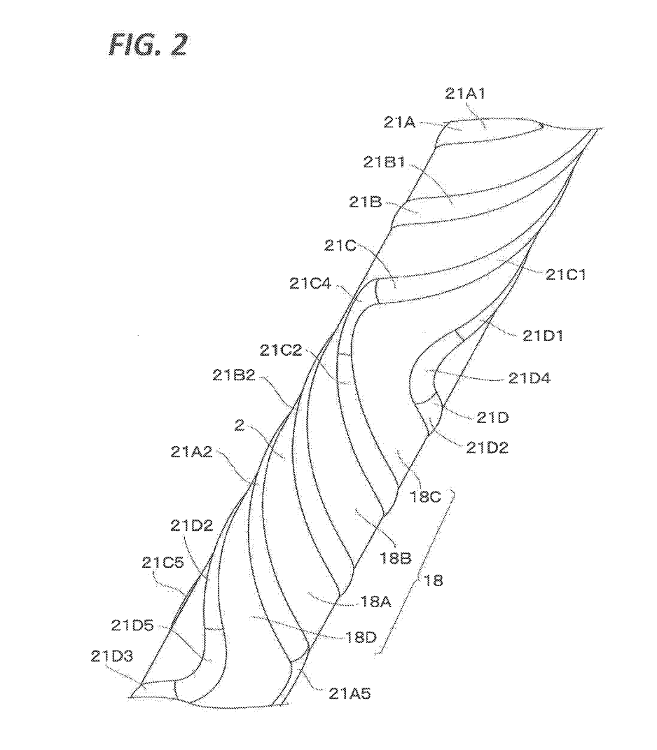

That is, the respective partition walls 21A, 21B, 21C, and 21D have first clockwise (right-rum) portions 21A1, 21B1, 21C1, and 21D1 which extend in the first oblique direction to become a first portion, counterclockwise (left-turn) portions 21A2, 21B2, 21C2, and 21D2 which extend in the second oblique direction opposite to the first oblique direction to become a second portion, and second clockwise (right-turn) portions 21A3, 21B3, 21C3, and 21D3 which extend in the first oblique direction to become a first portion. Further, the clockwise (right-turn) and the counterclockwise (left-turn) correspond to the flow direction of the working fluid 20 when viewing the intermediate cylinder 17 (shock absorber 1) from the upper end side (first end side) in the axial direction, that is, the flow direction of the working fluid 20 when viewing the intermediate cylinder 17 (shock absorber 1) from the upper side to the lower side in FIGS. 1 to 4.

In addition, the first clockwise portions 21A1, 21B1, 21C1, and 21D1 and the counterclockwise portions 21A2, 21B2, 21C2, and 21D2 are connected to one another by first connecting portions (first turning-back portions) 21A4, 21B4, 21C4, and 21D4. Further, the counterclockwise portions 21A2, 21B2, 21C2, and 21D2 and the second clockwise portions 21A3, 21B3, 21C3, and 21D3 are connected to one another by second connecting portions (second turning-back portions) 21A5, 21B5, 21C5, and 21D5. In this case, the first connecting portions 21A4, 21B4, 21C4, and 21D4 and the second connecting portions 21A5, 21B5, 21C5, and 21D5, that is, the connecting portions (turning-back portions) between the portions extending in the first oblique direction and the portions extending in the second oblique direction each may have a thickness greater than thicknesses of other portions (e.g., in the circumferential direction or the radial direction of the inner cylinder 2). Therefore, the portion to which the highest force of the fluid is applied by the functional fluid may have a large thickness such that a load applied to a portion on which stress is concentrated may be reduced.

Here, the circumferential directions of the partition walls 21A, 21B, 21C, and 21D vary in response to the viscosity distribution of the working fluid 20 in the flow paths 18A, 18B, 18C, and 18D. Specifically, the respective partition walls 21A, 21B, 21C, and 21D are set to eliminate the moment (torque, rotational force) caused by shear resistance applied to the intermediate cylinder 17 when the working fluid 20 flows along the respective partition walls 21A, 21B, 21C, and 21D. That is, a first relative rotational force (e.g., clockwise force), which is generated by the first oblique direction, between the intermediate cylinder 17 and the outer cylinder 3, and a second relative rotational force (e.g., counterclockwise force), which is opposite to the first relative rotational force and generated by the second oblique direction, between the intermediate cylinder 17 and the outer cylinder 3 are brought close to the same magnitude. In other words, the shapes of the respective partition walls 21A, 21B, 21C, and 21D are set such that the first relative rotational force and the second relative rotational force are nearly equal to each other.

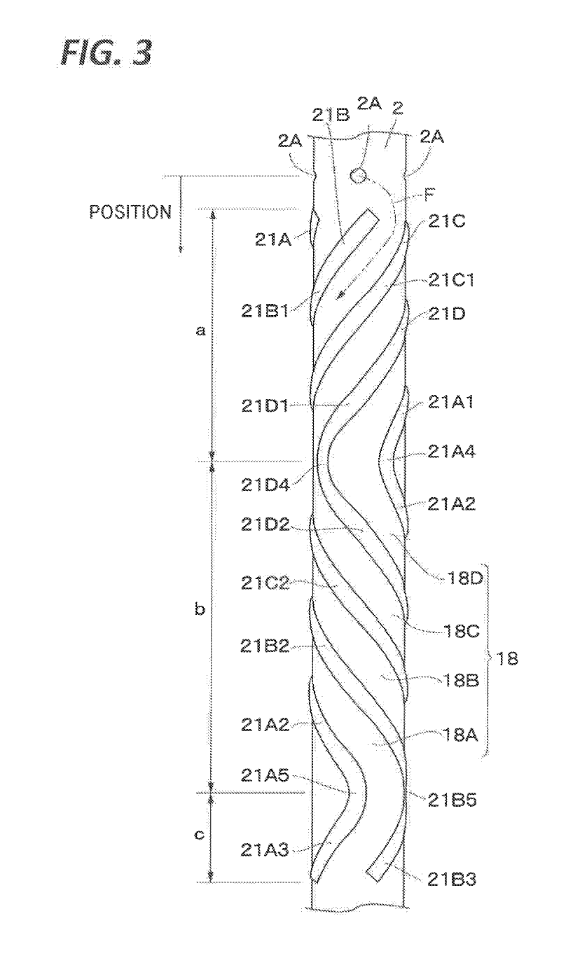

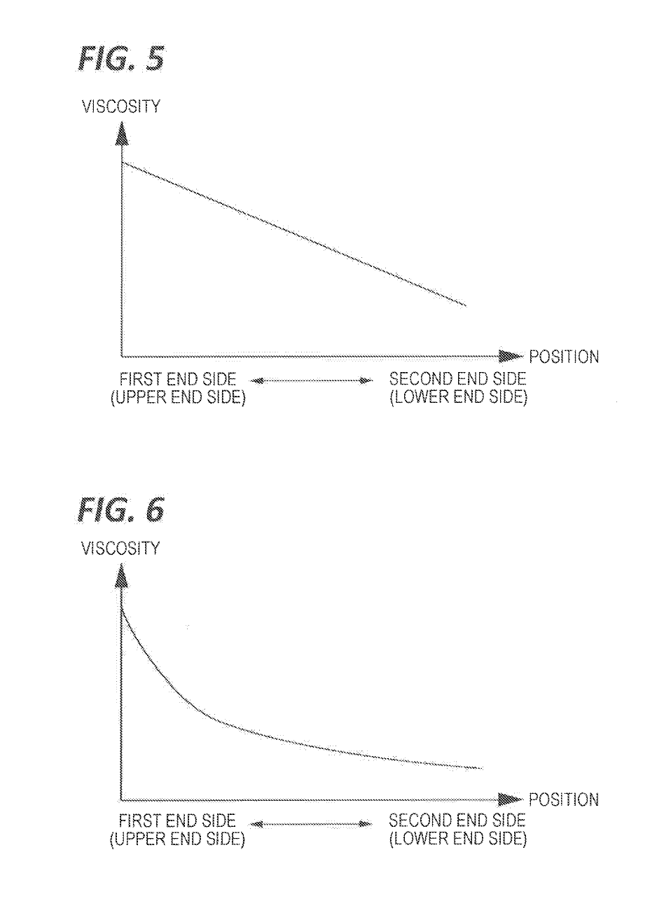

For example, in a case in which the viscosity distribution in the flow paths 18 (18A, 18B, 18C, and 18D) is linear as illustrated in FIG. 5, the sum of the length a and the length c and the length b, which are indicated in FIG. 3, are set to be equal to each other (a+c−b) so that the axial lengths of the respective partition walls 21A, 21B, 21C, and 21D in the two directions (the clockwise and counterclockwise rotations) are equal to one another. In addition, in a case in which the viscosity distribution in the flow paths 18 (18A, 18B, 18C, and 18D) is not linear as illustrated in FIG. 6, the sum of the torque applied to the intermediate cylinder 17 and the torque applied to the inner cylinder 2 may be set to zero (nearly zero) by shortening the length a and making the length b longer than the length a (a<b).

In other words, the axial lengths of the respective partition walls 21A, 21B, 21C, and 21D in the two directions (the clockwise and the counterclockwise rotations) need not be equal to one another. For example, the axial length in one direction (the clockwise or counterclockwise rotation) may be shortened (a short flow path may be made) at the upstream side (upper end side) where the pressure (shear resistance) is high, and the axial length in the other direction (the counterclockwise or clockwise rotation) may be lengthened (a long flow path may be made) at the downstream side (lower end side) where the pressure is low. An axial length, a circumferential length, and an inclination (inclination degree) of a first portion (the portion extending in the first oblique direction) and an axial length, a circumferential length, and an inclination (inclination degree) of a second portion (the portion extending in the second oblique direction) may be adjusted (timed) based on, for example, experiments, simulation, calculation formulas, and the like so that the rotational force, which is applied to the intermediate cylinder 17 from the working fluid 20 flowing through the flow paths 18 (18A, 18B, 18C, 18D), becomes a desired value (e.g., the sum thereof becomes zero or nearly zero).

Here, for example, the respective partition walls 21A, 21B, 21C, and 21D may be made of a polymeric material (a resin material including synthetic resin, a rubber material including synthetic rubber, etc.) having an electrically insulating property. In this case, for example, the respective partition walls 21A, 21B, 21C, and 21D may be integrally formed by covering the outer circumferential surface of the inner cylinder 2 with a mold which is divided into four pieces in the circumferential direction, and performing injection molding of the polymeric material with respect to the inner cylinder 2. In addition, for example, the respective partition walls 21A, 21B, 21C, and 21D, which are molded in advance, may be attached to the inner cylinder 2.

The shock absorber 1 according to the exemplary embodiment has the aforementioned configurations, and the operation of the shock absorber 1 will be described below.

When mounting the shock absorber 1 in the vehicle such as an automobile, for example, the upper end side of the piston rod 8 is mounted at the vehicle body side of the vehicle, and the lower end side (the bottom cap 4 side) of the outer cylinder 3 is mounted at the wheel side (axle side). When vibrations in the up and down directions occur due to the unevenness of a road surface while the vehicle travels, the piston rod 8 is displaced to be extended from and retracted into the outer cylinder 3. In this case, a potential difference is generated in the flow path 18 based on a command from the controller, and the viscosity of the working fluid 20 flowing through the oil passage, that is, the electrorheological fluid is controlled such that the generated damping force of the shock absorber 1 is variably regulated. For example, during the extension stroke of the piston rod 8, the retraction side check valve 6 of the piston 5 is closed as the piston 5 is moved in the inner cylinder 2. Before the disk valve 7 of the piston 5 is opened, the oil (working fluid 20) in the rod side oil chamber B is pressurized, and flows into the flow path 18 through the oil hole 2A of the inner cylinder 2. In this case, the oil corresponding to the movement of the piston 5 opens the extension side check valve 15 of the bottom valve 12 and flows into the bottom side oil chamber C from the reservoir chamber A.

Meanwhile, during the retraction stroke of the piston rod 8, the retraction side check valve 6 of the piston 5 is opened as the piston 5 is moved in the inner cylinder 2, and the extension side check valve 15 of the bottom valve 12 is closed. Before the bottom valve 12 (disk valve 16) is opened, the oil in the bottom side oil chamber C flows into the rod side oil chamber B. In addition, the oil corresponding to a degree to which the piston rod 8 is inserted into the inner cylinder 2 flows into the flow path 18 from the rod side oil chamber B through the oil hole 2A of the inner cylinder 2.

Even in any ease (i.e., even during the extension stroke and even during the retraction stroke), the oil flowing into the flow path 18 passes through the flow path 18 toward an outlet port side (lower side) with a viscosity in response to the potential difference (a potential difference between the intermediate cylinder 17 and the inner cylinder 2) of the flow path 18, and the oil flows info the reservoir chamber A from the flow path 18 through the oil passage 14A of the holding member 14. In this case, the shock absorber 1 generates the damping force in response to the viscosity of the oil passing through the flow path 18, thereby absorbing (buffering) vertical vibration of the vehicle.

Here, the working fluid 20, which is the oil flowing into the flow path 18 through the oil holes 2A (four oil hole 2A) of the inner cylinder 2, flows from the upper end side to the lower end side along the flow paths 18A, 18B, 18C, and 18D between the respective partition walls 21A, 21B, 21C, and 21D between the inner cylinder 2 and the intermediate cylinder 17. In this case, the rotational force (torque, moment) is applied to the inner cylinder 2 (and the intermediate cylinder 17) based on the shear resistance of the working fluid 20 flowing through the flow paths 18A, 18B, 18C, and 18D. However, a force applied from the working fluid 20 flowing between the first clockwise portions 21A1, 21B1, 21C1, and 21D1 of the respective partition walls 21A, 21B, 21C, and 21D and between the second clockwise portions 21A3, 21B3, 21C3, and 21D3 of the respective partition walls 21A, 21B, 21C, and 21D is opposite to a force applied from the working fluid 20 flowing between the counterclockwise portions 21A2, 21B2, 21C2, and 21D2 (the forces are canceled out). Therefore, the force applied to the inner cylinder 2 from the working fluid 20 flowing through the flow paths 18A, 18B, 18C, and 18D may be reduced overall (may become nearly zero).

As such, in the exemplary embodiment, it is possible to reduce the overall (sum of) rotational force (torque, moment) applied to the inner cylinder 2 from the working fluid 20.

That is, in the exemplary embodiment, the flow paths 18A, 18B, 18C, and 18D have the portions extending in the first oblique direction (between the first clockwise portions 21A1, 21B1, 21C1, and 21D1 and between the second clockwise portions 21A3, 21B3, 21C3, and 21D3) and the portions extending in the second oblique direction (between the counterclockwise portions 21A2, 21B2, 21C2, and 21D2. For this reason, the rotational forces applied to the inner cylinder 2 from the working fluid 20 flowing through the flow paths 18A, 18B, 18C, and 18D are opposite to one another at the portions extending in the first oblique direction and the portion extending in the second oblique direction.

That is, the first relative rotational force, which is generated by the first oblique direction, between the inner cylinder 2 and the intermediate cylinder 17 or between the intermediate cylinder 17 and the outer cylinder 3, may be opposite to the second relative rotational force, which is generated by the second oblique direction, between the inner cylinder 2 and the intermediate cylinder 17 or between the intermediate cylinder 17 and the outer cylinder 3. Therefore, it is possible to reduce the rotational force applied from the working fluid 20 flowing through the flow paths 18A, 18B, 18C, and 18D.

More specifically, in the exemplary embodiment, the first relative rotational force and the second relative rotational force are brought close to the same magnitude. For this reason, the first relative rotational force and the second relative rotational force are canceled, and the rotational force applied from the fluid flowing through the flow paths 18A, 18B, 18C, and 18D may be canceled (may become nearly zero as a whole). Therefore, the rotation stopper (e.g., the claw portion and the engaged portion with which the claw portion is engaged) between the inner cylinder 2 and the intermediate cylinder 17 or the outer cylinder 3 may be omitted (eliminated). For this reason, for example, it is possible to achieve simplification in the shape of a portion provided with the rotation stopper (e.g., the shape of an end surface of the outer cylinder), reduction in the number of components and the number of processes, and an improvement in assemblability. As a result, in addition to obtaining an advantage in terms of durability, and productivity may be improved. Furthermore, the rotational force applied to the inner cylinder 2 may become nearly zero as a whole, and as a result, it is possible to obtain a desired damping force in comparison with the configuration in which the rotational force is applied. That is, it is possible to suppress energy absorption caused by the rotation of the inner cylinder 2, and to efficiently convert the energy into pressure (flow resistance).

In the exemplary embodiment, the connecting portions between the portions extending in the first oblique direction and the portions extending in the second oblique direction, that is, the first connecting portions 21A4, 21B4, 21C4, and 21D4 and the second connecting portions 21A5, 21B5, 21C5, and 21D5 each may have a thickness greater than thicknesses of other portions (e.g., in the circumferential direction or the radial direction of the inner cylinder 2). In this case, it is possible to secure strength and improve durability of the first connecting portions 21A4, 21B4, 21C4, and 21D4 and the second connecting portion 21A5, 21B5, 21C5, and 21D5 to which the rotational forces, which are opposite to each other, are greatly applied.

Further, in the exemplary embodiment, a configuration in which in the flow paths 18A, 18B, 18C, and 18D, a first portion extending in the first oblique direction is provided at two locations, and a second portion extending in the second oblique direction is provided at one location is described as an example. That is, in the exemplary embodiment, a configuration in which in the partition walls 21A, 21B, 21C, and 21D, between the upper end (first end) and the lower end (second end), the clockwise portions extending in the first oblique direction are provided at the two locations (the first clockwise portions 21A1, 21B1, 21C1, and 21D1 and the second clockwise portions 21A3, 21B3, 21C3, and 21D3), and the counterclockwise portion extending in the second oblique direction is provided at the one location (the counterclockwise portions 21A2, 21B2, 21C2, and 21D2) is described as an example.

However, the present invention is not limited thereto, and, for example, a first portion extending in the first oblique direction may he provided at one location, and a second portion extending in the second oblique direction may be provided at one location. In addition, a first portion extending in the first oblique direction may be provided at one location, and a second portion extending in the second oblique direction may be provided at two locations. In addition, a first portion extending in the first oblique direction and a second portion extending in the second oblique direction may be provided at multiple locations, respectively. In this case, the number of first portions extending in the first oblique direction and the number of second portions extending in the second oblique direction may be equal to each other or different from each other. Even in any case, the first portions extending in the first oblique direction and the second portions extending in the second oblique direction may be alternately disposed in the axial direction.

In the exemplary embodiment, a configuration in which the working fluid 20 flows from the upper end side to the lower end side in the axial direction is described as an example. However, the present invention is not limited thereto, and, for example, it may be possible to adopt a configuration in which the working fluid 20 flows from a first end side to a second end side in the axial direction such as, for example, a configuration in which the working fluid 20 flows from the lower end side to the upper end side in the axial direction, a configuration in which the working fluid 20 flows from a left end side (or a right end side) to the right end side (or the left end side) in the axial direction, or a configuration in which the working fluid 20 flows from a front end side (or a rear end side) to the rear end side (or the front end side) in the axial direction.

In the exemplary embodiment, a configuration in which the intermediate cylinder 17 is prevented from being rotated relative to the outer cylinder 3 is described as an example. However, the present invention is not limited thereto, and, for example, it may be possible to adopt a configuration in which the flow path forming unit (intermediate cylinder) is prevented from being rotated relative to the inner cylinder.

In the exemplary embodiment, a configuration in which, for example, the rotation stopper (engaging portion), which includes the claw portion (convex portion) and the engaged portion (concave portion) with which the claw portion is engaged, is not provided (omitted) between the intermediate cylinder 17 and the outer cylinder 3 is described as an example. However, the present invention is not limited thereto, and, for example, it may be possible to adopt a configuration in which the rotation stopper (engaging portion), which includes the claw portion (convex portion) and the engaged portion (concave portion) with which the claw portion is engaged, is provided between the inner cylinder and the intermediate cylinder or between the intermediate cylinder and the outer cylinder, particularly, between the inner cylinder and the outer cylinder.

In the exemplary embodiment, a configuration in which the partition walls 21A, 21B, 21C, and 21D, which restrict the directions of the flow paths 18A, 18B, 18C, and 18D, are provided in the inner cylinder 2 (at the outer circumferential side of the inner cylinder 2) is described as an example. However, the present invention is not limited thereto, and, for example, the partition wall may be provided on the intermediate cylinder (at the inner circumferential side of the intermediate cylinder). In this case, similarly, the rotational force is applied to the intermediate cylinder, but the rotational force may be reduced by applying the present invention. In addition, it may be possible to adopt a configuration in which the partition walls 21A, 21B, 21C, and 21D, which restrict the directions of the flow paths 18A, 18B, 18C, and 18D, are provided on the outer cylinder 3. In this case, even though the rotational force (torque, moment) is applied to the outer cylinder 3, the rotational force (torque, moment) may be reduced.

In the exemplary embodiment, a configuration in which the four partition walls 21A, 21B, 21C, and 21D, which restrict the directions of the flow paths 18A, 18B, 18C, and 18D, are provided is described as an example. However, the present invention is not limited thereto, and, for example, a plurality of partition walls, such as two, three, five, or six partition walls may be provided, and the number of partition walls may be appropriately set in response to required performance (damping performance), manufacturing costs, specifications, and the like.

In the exemplary embodiment, a configuration in which the shock absorber 1 is disposed in the up and down direction is described as an example. However, the present invention is not limited thereto, and, for example, the shock absorber 1 may be disposed in a desired direction according to an object in which the shock absorber 1 is mounted, like a configuration in which the shock absorber 1 is disposed to be inclined within a range in which aeration does not occur.

In the exemplary embodiment, a configuration in which the working fluid 20, as the functional fluid, is configured as the electrorheological fluid is described as an example. However, the present invention is not limited thereto, and, for example, the working fluid, as the functional fluid, may be configured by using the magnetic fluid (MR fluid) having the fluid characteristics that are changed by the magnetic field. In the case in which the magnetic fluid is used, for example, it may possible to adopt a configuration in which the magnetic field is generated between the inner cylinder 2 and the intermediate cylinder 17, and the magnetic field may be variably controlled from the outside when variably adjusting the generated damping force. In addition, the insulating holding members 10 and 14 may be made of a non-magnetic material.

In the exemplary embodiment, a configuration in which the shock absorber 1, as the cylinder device, is used for a four-wheeled automobile is described as an example. However, the present invention is not limited thereto, and, for example, the shock absorber 1 may be widely used as various types of shock absorbers (cylinder devices) for a shock from an object to be shock-absorbed, such as a shock absorber used for a two-wheeled vehicle, a shock absorber used for a railway vehicle, a shock absorber used for various types of mechanical components including general industrial equipment, and a shock absorber used for a building.

According to the exemplary embodiment, it is possible to reduce the rotational force (torque, moment) applied from the fluid.

That is, in the exemplary embodiment, the flow path has the portion extending in the first oblique direction and the portion extending in the second oblique direction. For this reason, the rotational forces applied from the fluid flowing through the flow path are opposite to each other at the portion extending in the first oblique direction and the portion extending in the second oblique direction. That is, the first relative rotational force, which is generated by the first oblique direction, between the inner cylinder and the flow path forming unit or between the flow path forming unit and the outer cylinder, and the second relative rotational force, which is generated by the second oblique direction, between the inner cylinder and the flow path forming unit or between the flow path forming unit and the outer cylinder may be set to be opposite to each other. Therefore, it is possible to reduce the rotational force applied from the fluid flowing through the flow path. As a result, in the case in which the rotation stopper is provided, it is possible to reduce a size of the rotation stopper and to improve durability. Further, in the case in which the rotation stopper may be omitted (eliminated), productivity may be improved in addition to the improvement in durability.

According to the exemplary embodiment, the first relative rotational force, which is generated by the first oblique direction, between the inner cylinder and the flow path forming unit or between the flow path forming unit and the outer cylinder, and the second relative rotational force, which is opposite to the first relative rotational force and is generated by the second oblique direction, between the inner cylinder and the flow path forming unit and between the flow path forming unit and the outer cylinder, are brought close to the same magnitude. For this reason, the first relative rotational force and the second relative rotational force are canceled out, such that the rotational force applied from the fluid flowing through the flow path may be canceled out. Therefore, the rotation stopper may be omitted (eliminated), and, for example, a shape of the portion (e.g., a shape of an end surface of the outer cylinder) where the rotation stopper was provided may be simplified, the number of components may be reduced, the number of processes may be reduced, and assembly properties may be improved. As a result, the configuration may be advantageous in terms of durability, and productivity may be improved.

According to the exemplary embodiment, the connecting portion between the portion extending in the first oblique direction and the portion extending in the second oblique direction has a thickness greater than thicknesses of other portions. For this reason, it is possible to secure strength and improve durability of the connecting portion to which the rotational forces opposite to each other are greatly applied.

As the cylinder device according to the exemplary embodiment, for example, the following aspects may be provided.

As a first aspect, a cylinder device includes: an inner cylinder in which a functional fluid, a fluid property of which is changed due to an electric field or a magnetic field, is encapsulated, and into which a rod is inserted; an outer cylinder provided outside the inner cylinder; and a flow path forming unit provided between the inner cylinder and the outer cylinder so as to define a flow path through which the functional fluid flows by advancing and retracting movements of the rod from a first end side to a second end side in an axial direction, and configured to be relatively non-rotatable relative to the inner cylinder or the outer cylinder. The flow path obliquely extends around the inner cylinder or the flow path forming unit, and the flow path has a first portion extending in a first oblique direction and a second portion extending in a second oblique direction opposite to the first oblique direction.

According to a second aspect, in the first aspect, a first relative rotational force, which is generated by the first oblique direction, between the inner cylinder and the flow path forming unit or between the flow path forming unit and the outer cylinder and a second relative rotational force, which is opposite to the first rotational force and is generated by the second oblique direction, between the inner cylinder and the flow path forming unit or between the flow path forming unit and the outer cylinder are brought close to a same magnitude.

According to a third aspect, in the first or second aspect, a connecting portion between the first portion extending in the first oblique direction and the second portion extending in the second oblique direction has a thickness greater than a thicknesses of a portion other than the connecting portion.

According to a fourth aspect, a cylinder device includes: an inner cylinder in which a working fluid is encapsulated and into which a rod is inserted; an outer cylinder provided outside the inner cylinder; and a flow path forming unit provided between the inner cylinder and the outer cylinder so as to define a flow path through which the working fluid flows by advancing and retracting movements of the rod from a first end side to a second end side in an axial direction, and configured to be relatively non-rotatable relative to the inner cylinder or the outer cylinder. The flow path obliquely extends around the inner cylinder or the flow path forming unit, and the flow path has a first portion extending in a first oblique direction and a second portion extending in a second oblique direction opposite to the first oblique direction.

While only several exemplary embodiments of the present invention have been described above, it can be easily understood by those skilled in the art that various changes and modifications may be made to the exemplary embodiments without substantially departing from the novel teaching or advantages of the present invention. Therefore, the changed and modified aspects are also intended to be included in the technical scope of the present invention. The exemplary embodiments may be arbitrarily combined.

The present application claims priority to Japanese Patent Application No. 2015-171298 filed on Aug. 31, 2015. All disclosures, including the specification, claims, drawings, and abstract of Japanese Patent Application No. 2015-171298 filed on Aug. 31, 2015 are incorporated herein by reference in their entirety.

### DESCRIPTION OF SYMBOLS

1: Shock absorber (cylinder device)
2: Inner cylinder
3: Outer cylinder
5: Piston
8: Piston rod (rod)
17: Intermediate cylinder (flow path forming unit)
18 (18A, 18B, 18C, 18D): Flow path
20: Working fluid (fluid, functional fluid)
21A, 21B, 21C, 21D: Partition wall
21A1, 21B1, 21C1, 21D1: First clockwise portion (first portion)
21A2, 21B2, 21C2, 21D2: Counterclockwise portion (second portion)
21A3, 21B3, 21C3, 21D3: Second clockwise portion (first portion)
21A4, 21B4, 21C4, 21D4: First connecting portion (connecting portion)
21A5, 21B5, 21C5, 21D5: Second connecting portion (connecting portion)

1. A cylinder device comprising:
an inner cylinder in which a functional fluid, a fluid property of which is changed due to an electric field or a magnetic field, is encapsulated, and into which a rod is inserted;
an outer cylinder provided outside the inner cylinder; and
a flow path forming unit provided between the inner cylinder and the outer cylinder so as to define a flow path through which the functional fluid flows by advancing and retracting movements of the rod from a first end side to a second end side in an axial direction, and configured to be relatively non-rotatable relative to the inner cylinder or the outer cylinder,
wherein the flow path obliquely extends around the inner cylinder or the flow path forming unit, and
the flow path has a first portion extending in a first oblique direction and a second portion extending in a second oblique direction opposite to the first oblique direction.

2. The cylinder device of claim 1, wherein a first relative rotational force, which is generated by the first oblique direction, between the inner cylinder and the flow path forming unit or between the flow path forming unit and the outer cylinder and a second relative rotational force, which is opposite to the first rotational force and is generated by the second oblique direction, between the inner cylinder and the flow path forming unit or between the flow path forming unit and the outer cylinder are brought close to a same magnitude.

3. The cylinder device of claim 1, wherein a connecting
portion between the first portion extending in the first oblique direction and the second portion extending in the second oblique direction has a thickness greater than a thicknesses of a portion other than the connecting portion.

4. A cylinder device comprising:
an inner cylinder in which a working fluid is encapsulated and into which a rod is inserted;
an outer cylinder provided outside the inner cylinder; and
a flow path forming unit provided between the inner cylinder and the outer cylinder so as to define a flow path through which the working fluid flows by advancing and retracting movements of the rod from a first end side to a second end side in an axial direction, and configured to be relatively non-rotatable relative to the inner cylinder or the outer cylinder,
wherein the flow path obliquely extends around the inner cylinder or the flow path forming unit, and
the flow path has a first portion extending in a first oblique direction and a second portion extending in a second oblique direction opposite to the first oblique direction.
